(19) United States
(12) Patent Application Publication
(10) Pub. No.: US 2019/0044169 A1
(43) Pub. Date: Feb. 7, 2019

(54) IONIC LIQUID-FUNCTIONALIZED GRAPHENE OXIDE-BASED NANOCOMPOSITE ANION EXCHANGE MEMBRANES

(71) Applicant: Ohio University, Athens, OH (US)

(72) Inventors: John Adams Staser, Athens, OH (US); Omar Movil-Cabrera, Sector Guardarraya, Guayanilla, PR (US)

(73) Assignee: Ohio University, Athens, OH (US)

(21) Appl. No.: 16/074,901

(22) PCT Filed: Feb. 2, 2017
(86) PCT No.: PCT/US17/16204

§ 371 Date: Aug. 2, 2018

Related U.S. Application Data
(60) Provisional application No. 62/290,180, filed on Feb. 2, 2016.

(51) Int. Cl. H01M 8/1016; C01B 32/198

(52) U.S. Cl. CPC H01M 8/1016; H01M 2300/0071; H01M 2300/0091; C01B 32/198

(57) ABSTRACT

A chemical composition includes graphene oxide covalently bonded to an ionic liquid. A nanocomposite anion exchange membrane (26) includes graphene oxide; and an ionic liquid covalently bonded to the graphene oxide. A fuel cell (20) includes an anode (22); a cathode (24); and a nanocomposite anion exchange membrane (26) including graphene oxide; an ionic liquid covalently bonded to the graphene oxide; and a base membrane. A method of fabricating a nanocomposite anion exchange membrane (26) includes functionalizing graphene oxide with an ionic liquid to create a nanocomposite; and forming an anion exchange membrane (26) with the nanocomposite.

### CROSS-REFERENCE TO RELATED APPLICATIONS

This application claims priority to U.S. Provisional Application No. 62/290,181, the disclosure of which is hereby incorporated by reference herein in its entirety.

### TECHNICAL FIELD

The present invention relates generally to ionic liquid-functionalized graphene oxide, anion exchange membranes, and methods of making same and, more specifically, to ionic liquid-functionalized graphene oxide-based nanocomposite anion exchange membranes.

### BACKGROUND

Recently, the emerging field of fuel cells has become of significant importance due to the ability of fuel cells to transform chemical energy directly into electricity. Further, anion exchange membrane fuel cells (AEMFCs) have become of great importance due to the advantages these systems offer versus proton exchange membrane fuel cells (PEMFCs). Some of these advantages include: facile electrochemical kinetics, reduced fuel crossover, decreased CO poisoning, and the use of non-precious metal electrocatalysts. However, AEMFCs exhibit lower performance than PEMFCs due to problems related to the polyelectrolyte. For example, AEMs show lower ionic conductivity than PEMs due in part to the fact that the conductivity of hydroxyl (OH⁻) ions is intrinsically lower than that of protons (H⁺). Another concern with the use of AEMs is the degradation of their cationic groups in strong alkaline media.

In order to overcome these barriers, a wide variety of polymeric materials have been developed as AEMs. Some of these materials includes among others, homopolymers, heterogeneous membranes, semi-interpenetrating polymer networks (SIPNs), and nanocomposite membranes. Moreover, due to the improvements in nanotechnology, nanocomposite membranes have gained attention as polymer electrolyte membranes for fuel cell applications. There is an increasing need to provide improved AEMs that address one or more of the above drawbacks.

### SUMMARY

In an embodiment, a chemical composition includes graphene oxide covalently bonded to an ionic liquid. In another embodiment, a nanocomposite anion exchange membrane includes graphene oxide, an ionic liquid covalently bonded to the graphene oxide, and a base membrane.

According to another embodiment, a method of fabricating a nanocomposite anion exchange membrane includes functionalizing graphene oxide with an ionic liquid to create a nanocomposite, and forming an anion exchange membrane with the nanocomposite.

In a further embodiment, a fuel cell includes an anode, a cathode, and a nanocomposite anion exchange membrane. The nanocomposite anion exchange membrane includes graphene oxide and an ionic liquid covalently bonded to the graphene oxide.

### BRIEF DESCRIPTION OF THE DRAWINGS

FIG. 1 is a schematic representation of a method of making a nanocomposite anion exchange membrane according to an embodiment of the present invention.

FIG. 2 is schematic representation of a fuel cell according to an embodiment of the present invention.

### DETAILED DESCRIPTION

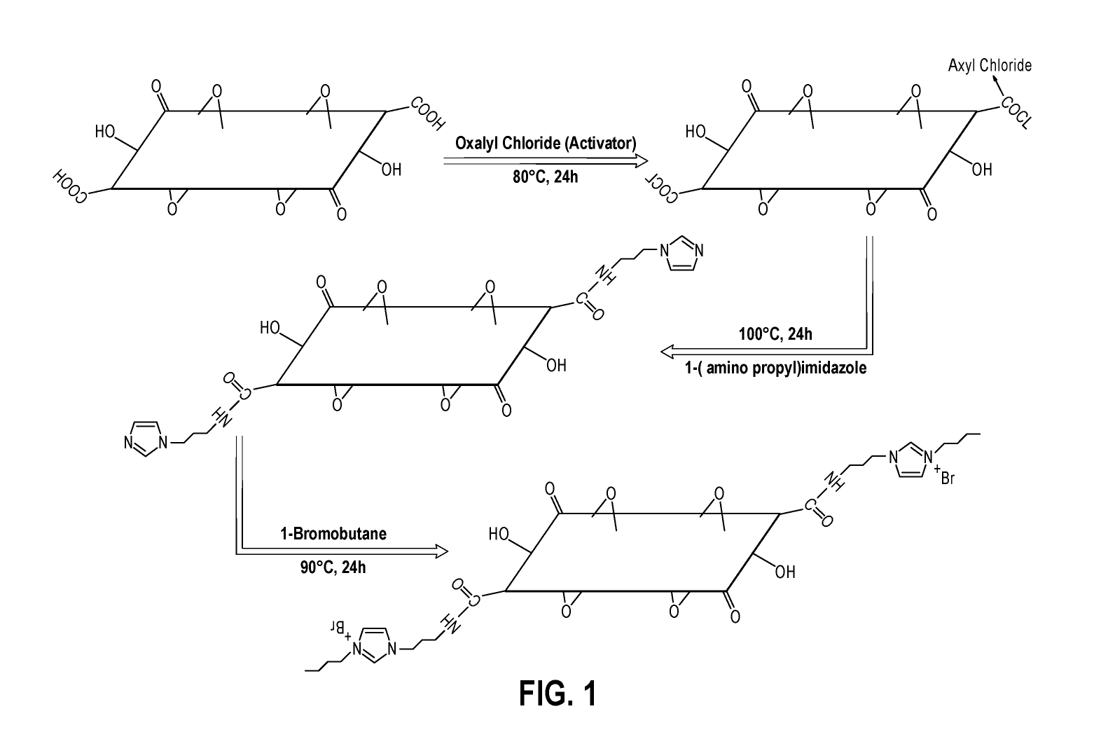

Embodiments of the present invention are directed to functionalized graphene oxide. Further embodiments are directed to ionic liquid-functionalized graphene oxide-based nanocomposite anion exchange membranes and to fuel cells using same. Additionally, embodiments of the present invention are directed to methods of making ionic liquid-functionalized graphene oxide, and nanocomposite anion exchange membranes including ionic liquid-functionalized graphene oxide. With reference to FIG. 1, in one embodiment, a nanocomposite anion exchange membrane (AEM) includes graphene oxide (GO) functionalized with an ionic liquid (IL), which may be used in a fuel cell (FC).

Graphene oxide provides an excellent platform for anion exchange membranes. GO is an attractive material for anion exchange applications due to its high surface area, hydrophilic nature, electronic insulation properties, and excellent mechanical stability. Furthermore, GO can be easily quaternized via physical or chemical approach, due to the presence of a significant amount of oxygen-containing groups at its surface (i.e., carboxylic groups).

Ionic liquids, which are poorly coordinated melted salts, are outstanding electrolytes because of their negligible volatility, high thermal and electrochemical stability, and excellent ionic conductivity even under anhydrous conditions. Thus, ionic liquids are attractive materials for anion exchange applications. These compounds generally include nitrogen groups as part of the cation and halide or other anions. The nitrogen groups can, for example, be alkyl substituted imidazolium or pyridinium cations. For example, the ionic liquid may be derived from a precursor such as 3-diethylamino propylamine, N, N dimethylethylenediamine, or 1-(3 aminopropyl) imidazole.

With reference to FIG. 1, the graphene oxide base is functionalized with an ionic liquid to create a GO/IL nanocomposite. In one embodiment, the ionic liquid is covalently bonded to the GO surface. To that end, the carboxylic acid groups present in the GO sheets may be activated (i.e., converted into acyl halide groups) using an activating agent. The activating agent may be, for example, oxalyl chloride, which would convert the carboxylic acid groups to acyl chloride groups. Those skilled in the art may recognize other suitable activating agents that may be used. The activating agent may be stirred with the GO at elevated temperatures for 24 hours, for example. After activation, the activating agent is removed from the activated GO, which is then washed and dried.

The activated GO is then functionalized with an ionic liquid to create the GO/IL nanocomposite. In one embodiment, where the ionic liquid is based on 1-(3 aminopropyl) imidazole, the imidazole groups may be covalently grafted to the acyl halide groups of the activated GO. For example, the activated GO may be added to IL precursor and stirred under a nitrogen atmosphere at an elevated temperature for 24 hours. Alternatively, the IL or its precursor can be reacted directly with the carboxylic acid functionality of the GO. After the reaction is complete, the solids may be separated from the liquids, washed, and dried. The ionic liquid is then formed via N-alkylation of the nitrogen containing groups (e.g., the imidazole groups where the initial compound is 1-(3 aminopropyl) imidazole) attached to the graphene oxide base. In one embodiment, the imidazole-modified graphene oxide may be reacted with 1-bromobutane at elevated temperatures under stirring. Once the alkylation reaction is complete, the GO/IL nanocomposite may be extracted via, for example, filtration, and may then be washed and dried. The ratio of GO to IL may vary. For example, the GO:IL ratio may range from about 50:50 up to and including about 75:25 by weight.

The GO/IL nanocomposite may be useful in a number of applications, such as water treatment, desalination, or an ion-exchange process. In one embodiment, the GO/IL nanocomposite is used to form a nanocomposite anion exchange membrane (GO/IL/AEM). In one embodiment, a polyelectrolyte fuel cell membrane, such as a Fumapem® membrane available from Fumatech BTW Group, may be used as a base membrane for the GO/IL/AEM nanocomposite. A first solution including the base membrane composition may be made. For example, the base membrane may be dissolved in a solvent, such as ethanol, under sonication. A second solution of the GO/IL nanocomposite may also be formed. The GO/IL nanocomposite may be dissolved, for example, in ethanol under sonication. The first and second solutions may be mixed. The content of the GO/IL nanocomposite in the AEM may be, without limitation, about 2.5 wt %, about 5 wt %, about 10 wt %, or about 20 wt %. The content of the GO/IL nanocomposite in the AEM may range from 2.5 wt % up to and including about 20 wt %, may range from 2.5 wt % up to and including about 10 wt %, may range from 5 wt % up to and including about 20 wt %, or may range from 5 wt % up to and including about 10 wt %. After the solutions are adequately mixed, the solutions may be cast to form the GO/IL/AEM nanocomposite and the solvent may be removed. In one embodiment, the GO/IL/AEM nanocomposite may be cast onto a surface, such as a glass plate.

The thickness of the AEM may vary. For example, the thickness of the cast membrane may be about 80 μm to about 120 μm. The solvent may then be evaporated from the cast solution. Then, the GO/IL/AEM nanocomposite may be altered such that it will conduct anions. More specifically, the GO/IL/AEM nanocomposite may be converted to the hydroxyl (OH⁻) form via, for example, an ion exchange process. In one embodiment, the GO/IL/AEM nanocomposite may be converted to the hydroxyl (OH⁻) form by being soaked in a KOH aqueous solution and subsequently washed.

The GO/IL/AEM nanocomposite has improved properties as compared to the base membrane alone. For example, the OH⁻ conductivity of a GO/IL/AEM nanocomposite using a Fumapem® membrane as the base membrane is greater than the OH⁻ conductivity of the Fumapem® membrane, as described further in Example 1 below. Further, the greater the content (i.e., wt %) of the GO/IL nanocomposite in the AEM, the greater is the effect on the OH⁻ conductivity. The positive effect of the inclusion of the GO/IL nanocomposite, which is a hydrophilic material with high surface area, into the polymer matrix may be that the GO/IL nanocomposite promotes high water uptake. According to the Grotthus mechanism theory, water uptake facilitates the transfer of OH⁻ through the membranes. Further, the presence of the quaternary imidazolium groups in the GO/IL nanocomposite extends the number of available ion exchange sites in the AEM, which further facilitates the OH⁻ mobility in the membranes.

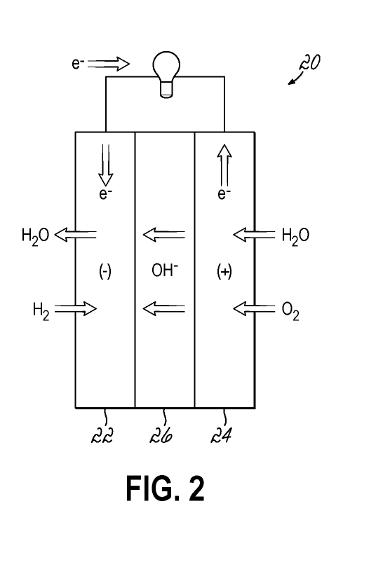

With reference to FIG. 2, in one embodiment, a GO/IL/AEM nanocomposite may be used in a fuel cell 20. The fuel cell 20 includes an anode 22, a cathode 24, and a GO/IL/AEM nanocomposite 26. A fuel cell performance improvement may be observed in the fuel cell 20 with the GO/IL/AEM nanocomposite 26 as compared to a fuel cell having the base membrane used in the GO/IL/AEM nanocomposite. For example, the open circuit voltage and the maximum power density may be improved by about 25%, for example.

Those skilled in the art will recognize that ionic liquid-functionalized graphene oxide-based nanocomposite anion exchange membranes according to embodiments of the present invention may be used in other anion exchange applications.

In order to facilitate a more complete understanding of the embodiments of the invention, the following non-limiting example is provided.

### Example 1

Materials.

Graphene oxide (GO) powder was acquired from Graphene Supermarket and used as received. Fumapem® commercial membranes were purchased from Fumatech BTW Group. Oxalyl chloride (98%), inhibitor-free anhydrous tetrahydrofuran (THF 99.9%), 1-(3-aminopropyl) imidazole (97%), 1-bromobutane, ethanol 99.5%, and methylene chloride (99.8%) were acquired from Sigma-Aldrich, USA. Potassium hydroxide (KOH) was purchased from Fisher Scientific.

Synthesis of GO/IL Nanocomposite.

GO sheets were chemically functionalized with imidazolium groups following the modified procedure proposed by Karousis et al. as shown schematically in FIG. 1. Firstly, the carboxylic groups present in the GO sheets were activated using oxalyl chloride as the activating agent. Specifically, 200 mg of GO were stirred in 50 mL of oxalyl chloride at 50° C. for 24 hours. Then, the excess oxalyl chloride was removed by filtration at room temperature. The remaining solids were washed with THF and filtered using a 0.2 μm PTFE filter. This washing process was repeated three times. Once washed, the activated GO was dried at room temperature overnight. Next, the activated GO was functionalized with the imidazole groups via covalent grafting. In this example, 150 mg of activated GO were mixed with 75 mL of 1-(3-aminopropyl) imidazole and stirred under a nitrogen atmosphere at 100° C. for 24 hours. Once the reaction was completed, the solids were separated by filtration and washed with methylene chloride. After repeating the washing process three times, the remaining solids were dried at room temperature. Next, the imidazole groups attached to GO underwent N-alkylation. For this purpose, 100 mg of imidazole-modified GO was reacted with 70 mL of 1-bromobutane under stirring at 90° C. Once the alkylation reaction was completed, the GO/IL nanocomposite was extracted by filtration. The GO/IL nanocomposite underwent a four-step washing process where the GO/IL nanocomposite was washed twice with THF and twice with D.I. water. Finally, the GO/IL nanocomposite was dried at room temperature overnight.

Synthesis of GO/IL/AEM Nanocomposite.

Initially, a first solution was made by dissolving Fumapem® FAA-3 membranes in ethanol at room temperature under sonication until homogenous solutions were achieved. Then, a second solution was made by dissolving appropriate amounts of the GO/IL nanocomposite in ethanol via sonication. The first and second solutions were combined in order to obtain membranes with filler contents of 2.5 wt %, 5 wt %, and 10 wt %. The combined solutions were sonicated for 4 hours and then stirred at room temperature overnight. After mixing, the combined solutions were cast onto glass plates using a blade-casting machine with a thickness of 130 μm, followed by overnight solvent evaporation at room temperature in a fume hood. The prepared membranes were converted to their hydroxyl form (OH⁻) via ion exchange process. In this example, each membrane was soaked in a 1M KOH aqueous solution for 4 hours and then washed several times with D.I. water until the pH value of the wash water was neutral.

GO and GO/IL Nanocomposite Characterization Techniques. The effects of the GO/IL content on the morphology, thermal behavior, and OH⁻ conductivity of the nanocomposites were studied. The material properties of the GO and the GO/IL nanocomposites were characterized using a variety of methods. Fourier transform infrared (FTIR) was performed using a Bruker Vertex80 FT-IR spectrometer. The spectral range for this study was from 400 to 4000 cm⁻¹ with a resolution of 4 cm⁻¹ and 100 scans per sample. Thermal gravimetric analysis (TGA) was performed using a SDT Q600 T.A. instrument operating with a constant nitrogen flow. These scans were performed at a heating rate of 5° C./min from 50° C. to 500° C. The UV-Vis spectra were obtained utilizing a Hewlett Packard 8452A Diode Array Spectrophotometer in the wavelength range of 190 nm to 400 nm. In order to perform the UV-Vis analysis, the samples were previously diluted in D.I. water. High-resolution transmission electron microscopy (HRTEM) studies were performed on a JOEL-2100F microscope.

Fourier Transform Infrared (FTIR) Analysis.

FTIR experiments were performed to obtain information about the chemical structure of GO after and before its functionalized with the imidazolium groups. As expected, the presence of oxygen-containing functionalities in graphene oxide was confirmed by the peaks observed at 1800 cm⁻¹, 1600 cm⁻¹, 1400 cm⁻¹, and 1200 cm⁻¹. The peaks at 1800 cm⁻¹ and 1600 cm⁻¹ correspond to the C═O and C═C bonds vibration, respectively, whereas the peaks observed at 1400 cm⁻¹ and 1200 cm⁻¹ correspond to the vibrations of carboxy (C—O) and epoxy (C—O) bonds, respectively. In the case of the GO/IL nanocomposite, it is possible to appreciate significant differences as compare to unmodified GO. Firstly, a peak is observed at 1470 cm⁻¹ that suggests the presence of C═N bonds in the modified GO sheets. The formation of C═N bonds is a result of the reaction between the activated carboxylic groups presents in edges of the GO sheets and the 1-(3-aminopropyl) imidazole molecules. Also, bands were observed at 2850 cm⁻¹ and 2920 cm⁻¹, which correspond to the symmetric vibration of —CH₂ bonds present in the molecules covalently grafted to GO. In addition, peaks observed at 1160 cm⁻¹ and 754 cm⁻¹ suggest the presence of imidazolium functional groups in the modified GO. As mentioned above, imidazole functionalities present in GO are converted in imidazolium cations via N-alkylation using 1-bromobutane. These findings suggest that the GO sheets have been successfully functionalized with the imidazolium groups via the covalent grafting approach.

UV-Vis Spectra Analysis.

The GO functionalization was also corroborated via UV-Vis analysis. As expected, the GO spectrum exhibited a maximum absorption band at 230 nm. In contrast, the GO/IL spectrum showed the typical absorption peak of imidazolium groups at 210 nm, which suggest the presence of imidazolium moieties in the GO sheets after functionalization.

Thermal Gravimetric Analysis (TGA).

TGA experiments were performed to corroborate the functionalization of GO with the imidazolium ionic liquid. The GO thermogram showed three major weight loss steps. The first of these steps (T<100° C.) is generally related to the evaporation of the moisture adsorbed on the GO surface. The second step (150°-200° C.) can be associated with the pyrolysis of the labile oxygen-containing functional groups. The last step (200° C.-300° C.) has been previously assigned to the decomposition of more stable oxygen-containing functional groups present in the GO structure. It is also possible to appreciate how the functionalization of GO can improve its thermal stability at temperatures lower than 250° C. This improvement may be attributed to the reduction of the number of oxygen-containing groups in the GO structure after functionalization. Contrarily, at temperatures higher than 250° C., the thermal stability of the GO/IL decreases significantly as compared to the unmodified GO. This may be due to the decomposition of the imidazolium moieties present in the GO/IL structure. These results also indicate that the composition (wt %) of the obtained GO/IL is 64% GO and 36% imidazolium ionic liquids.

High-Resolution Transmission Electron Microscopy (HRTEM) Analysis.

HRTEM studies were performed to evaluate the GO surface before and after functionalization with the imidazolium ionic liquid. The photographs clearly showed some differences for the GO surface before and after functionalization. Particularly, the GO/IL surface exhibited some dark areas, which do not appear in the unmodified GO. The dark areas observed in the GO/IL surface may be attributed to the presence of the imidazolium groups.

Fumapem® and GO/IL/AEM Nanocomposite Characterization Techniques.

The visual characteristics of the Fumapem® and the GO/IL/AEM nanocomposite were compared. The morphology of the GO/IL/AEM nanocomposites were evaluated via a scanning electron microscope (SEM) for the membranes fabricated with GO/IL contents of 0 wt %, 2.5 wt %, 5 wt %, and 10 wt %. The material properties of the Fumapem® and the GO/IL/AEM nanocomposite were also characterized using a variety of methods. The hydroxyl (OH⁻) conductivities for the GO/IL/AEM nanocomposites were measured using the four point impedance spectroscopy method. The OH⁻ conductivities were evaluated at different temperatures ranging from 30° C. to 90° C. at 100% relative humidity (RH). More specifically, a beaker with water was placed in a sealed oven and then a conductivity cell was placed inside the oven above the beaker. For these experiments, the temperature was controlled by a Watlow temperature controller, and the impedance measurements were performed on a VersaSTAT 3 potentiostat from Princeton Applied Research over the frequency range of 1 MHz to 0.1 Hz. Additionally, the ionic conductivity (σ) was calculated using the mathematical relation described by Equation 1:

$$σ = \frac{L}{R wt}$$

where L is the length of the membrane, R is the membrane resistance, w is the width of the membrane, and t is the thickness of the membrane. Finally, the thermal stability of these membranes was studied via TGA.

Visual Analysis.

As expected, the recast Fumapem® membrane (0 wt % GO/IL) exhibited its characteristic yellow color and transparency. After the incorporation of GO/IL, the nanocomposite membranes were completely opaque with an intense black color. The Fumapem® membrane transparency disappears after addition of GO/IL, due at least in part to the optical scattering caused for the agglomeration of the fillers into the polymer matrix.

SEM Analysis.

For the image of the recast Fumapem® membrane (0 wt % GO/IL), it was possible to appreciate an amorphous structure with some polymer aggregates randomly distributed into the polymer matrix. At GO/IL filler contents of 2.5 wt % and 5 wt %, the membranes also showed an amorphous morphology, but with some GO/IL sheets randomly oriented along the film thickness. Contrarily, at high filler content (e.g., 10 wt %) the membrane exhibited an ordered morphology with the GO/IL layers aligned parallel to the film surface. The ordered structure obtained at high filler content is a result of the gravitational forces experienced by the GO/IL sheets while remaining well dispersed in the viscous polymer solution. After solvent evaporation, the GO/IL sheets self-assemble forming a layer-by-layer stacking with a preferential orientation.

Four Point Impedance Spectroscopy Analysis.

Four point impedance spectroscopy tests were performed under different temperature conditions on the nanocomposite and commercial Fumapem® membranes in order to study the effects of temperature and filler content on the OH⁻ conductivity of these materials. The results indicated that, in terms of OH⁻ conductivity, temperature has a positive effect on the nanocomposite membranes. For the recast Fumapem® membrane (0 wt % GO/IL), the OH⁻ conductivity increases from 11.30 mScm⁻¹ to 14.75 mScm⁻¹ in the temperature range from 30° C. to 50° C. At temperatures higher than 50° C., the OH⁻ conductivity remains relatively constant with an average value of 15.61 mScm⁻¹. For the GO/IL/AEM nanocomposites with GO/IL contents of 2.5 wt %, 5 wt %, and 10 wt %, the OH⁻ conductivity increases with the temperature reaching the maximum values of 20.5 mScm⁻¹, 27.5 mScm⁻¹, and 32.1 mScm⁻¹, respectively, at 90° C. In contrast, the OH⁻ conductivity for the commercial Fumapem® membrane remains almost constant (i.e., about 18 mScm⁻¹) in the temperature range from 30° C. to 70° C., and then it increases slightly up to 20 mScm⁻¹ when the temperature reaches 90° C. However, for all of the nanocomposite membranes, the noticeable increment in conductivity with temperature is consistent with the general trend of increasing conductivity with increasing temperatures in many ion exchange membranes. The results also revealed that the inclusion of GO/IL into the commercial Fumapem® membranes has a positive effect on the OH⁻ conductivity of this material. For example, the OH⁻ conductivity (at 90° C.) increases from 16.5 mScm⁻¹ to 32.1 mScm⁻¹ as the filler content increases from 0 wt % to 10 wt %. A possible explanation for these findings is that the high GO/IL content (hydrophilic material with high surface area) into the polymer matrix promotes high water uptake, which, according to the Grotthus mechanism theory, facilitates the transfer of OH⁻ through the membranes. Also, the presence of quaternary imidazolium groups in GO/IL extends the number of available ion exchange sites, which further facilitates the OH⁻ mobility in the nanocomposite membranes.

Thermal Gravimetric Analysis (TGA).

TGA experiments were performed to analyze the thermal stability of the membranes. A significant difference was clearly observed in terms of thermal behavior between the thermogram of the recast Fumapem® membrane (0 wt % GO/IL) and the thermogram of the nanocomposite membrane with 10 wt % GO/IL. Particularly, the recast Fumapem® membrane (0 wt % GO/IL) showed three major weight loss steps. The first weight loss step (50° C.-150° C.) can be attributed to the evaporation of adsorbed water and solvent (i.e., ethanol). The second weight loss step (200° C.-380° C.) is generally attributed to the thermal decomposition of quaternary cations. The last weight loss step (T>380° C.) can be assigned to the degradation of the polymer matrix. In the case of the nanocomposite membrane, the thermogram also exhibited the weight loss step associated to the water and solvent evaporation. However, the second weight loss step begins at lower temperatures (150° C.-280° C.), which can be related to the decomposition of both the oxygen-containing functional groups and imidazolium ionic-liquid cations presents in the GO surface. The third weight loss step (280° C.-400° C.) can also correspond to the decomposition of the quaternary cations presents into the polymer matrix. A slight weight loss step can be also observed at temperatures higher than 400° C. as a result of the polymer matrix decomposition. These results clearly indicated that the recast Fumapem® membrane is thermally more stable than the nanocomposite membrane. Contrarily, at temperatures higher than 280° C., the nanocomposite membrane exhibited a more stable behavior than recast Fumapem® as a consequence of the strong interaction between the polymer and the GO/IL sheets at the interface. It is also possible that the polymer chain mobility is hampered by the stacking of GO layers, which takes place at a filler content of 10 wt %.

Fuel Cell Device Characterization Techniques.

The material properties of alkaline H₂/O₂ fuel cell devices using the Fumapem® membrane and using the GO/IL/AEM nanocomposite were characterized. High performance gas diffusion electrodes (GDE) from Fuel cell, Etc. loaded with 4 mg Pt black/cm² were used as the respective anode and cathode without previous optimization with any anionic ionomer binder. The device was a single cell fuel cell from Scribner Associates, Inc. The experiments were performed at about 25° C. using humidified oxygen and hydrogen flow rates of 20 mL/min. The Scribner's Fuel Cell software suite was used to control the cell potential as well as to record data once the system reached steady state at every predetermined potential. Of note, the fuel cell electrodes were not optimized. Instead, they were commercial GDEs without any anion exchange ionomer added as a binder. Therefore, the results were interpreted only to compare the performance of the commercial Fumapem® membrane to the GO/IL/fumapem nanocomposite membrane.

Fuel Cell Device Analysis.

The alkaline fuel cell with the commercial Fumapem® membrane exhibited an open circuit voltage (OCV) of 1.02 V and a peak power density of 5.085 mWcm⁻² at a current density of 15 mAcm⁻². For the fuel cell operated with the nanocomposite membrane (10 wt % GO/IL), it was possible to observe a fuel cell performance improvement. More specifically, the open circuit was 1.41 V, and the maximum power density reached was 6.345 mWcm⁻² at a current density of 15 mAcm⁻². Thus, an improvement of about 25% was observed in the fuel cell performance when the nanocomposite membrane with an GO/IL content of 10 wt % was used as an AEM as compared to commercial Fumapem®.

In summary, the results confirmed that GO was successfully functionalized with the imidazolium ionic liquids using a covalent bonding approach. The nanocomposite membrane was obtained via solvent-casting method from a solution containing the GO/IL nanocomposite homogenously dispersed in Fumapem®. The results revealed that the inclusion of GO/IL into the commercial Fumapem® membranes has a positive effect on both the OH⁻ conductivity and thermal stability of this polyelectrolyte membrane, especially at high temperature. It is believed that a high GO/IL content promotes high water uptake, which can facilitate the transfer of OH⁻ through the membranes. Also, the presence of quaternary imidazolium groups in the GO/IL nanocomposite extends the number of available ion exchange sites in the membrane, which further facilitates the OH⁻ mobility in these nanocomposite materials.

While all of the invention has been illustrated by a description of various embodiments and while these embodiments have been described in considerable detail, it is not the intention of the Applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the Applicants' general inventive concept.

What is claimed is:

1. A chemical composition comprising graphene oxide covalently bonded to an ionic liquid.

2. The composition of claim 1, wherein the ionic liquid is derived from one of 3-diethylamono propylamine, N, N dimethylethylenediamine, or 1-(3 aminopropyl) imidazole.

3. The composition of claim 1, wherein a ratio of the graphene oxide to the ionic liquid is from about 50:50 up to and including about 75:25 by weight.

4. A nanocomposite anion exchange membrane comprising:
graphene oxide; and
an ionic liquid covalently bonded to the graphene oxide.

5. The membrane of claim 4, further comprising:
a base membrane.

6. The membrane of claim 5, wherein the base membrane is a polyelectrolyte fuel cell membrane.

7. The membrane of claim 4, wherein the ionic liquid is derived from one of 3-diethylamono propylamine, N, N dimethylethylenediamine, or 1-(3 aminopropyl) imidazole.

8. The membrane of claim 4, wherein a ratio of the graphene oxide to the ionic liquid is from about 50:50 up to and including about 75:25 by weight.

9. The membrane of claim 4, wherein the nanocomposite anion exchange membrane includes up to about 20 wt % of the graphene oxide and the ionic liquid.

10. A fuel cell comprising:
an anode;
a cathode; and
a nanocomposite anion exchange membrane comprising:
graphene oxide;
an ionic liquid covalently bonded to the graphene oxide; and
a base membrane.

11. The fuel cell of claim 10, wherein the ionic liquid is derived from one of 3-diethylamono propylamine, N, N dimethylethylenediamine, or 1-(3 aminopropyl) imidazole.

12. The fuel cell of claim 10, wherein a ratio of the graphene oxide to the ionic liquid is from about 50:50 up to and including about 75:25 by weight.

13. The fuel cell of claim 10, wherein the nanocomposite anion exchange membrane includes up to about 20 wt % of the graphene oxide and the ionic liquid.

14. A method of fabricating a nanocomposite anion exchange membrane comprising:
functionalizing graphene oxide with an ionic liquid to create a nanocomposite; and
forming an anion exchange membrane with the nanocomposite.

15. The method of claim 14, wherein functionalizing graphene oxide with the ionic liquid includes covalently bonding the ionic liquid to the graphene oxide.

16. The method of claim 15, wherein functionalizing graphene oxide with the ionic liquid includes activating the graphene oxide before covalently bonding the ionic liquid to the graphene oxide.

17. The method of claim 14, wherein forming an anion exchange membrane includes mixing the nanocomposite with a base membrane.
